(19) United States
(12) Patent Application Publication
(10) Pub. No.: US 2014/0002732 A1
(43) Pub. Date: Jan. 2, 2014

(54) METHOD AND SYSTEM FOR TEMPORAL FRAME INTERPOLATION WITH STATIC REGIONS EXCLUDING

(71) Applicants: Marat R. Gilmutdinov, Saint-Petersburg (RU); Anton Veselov, Saint-Petersburg (RU)

(72) Inventors: Marat R. Gilmutdinov, Saint-Petersburg (RU); Anton Veselov, Saint-Petersburg (RU)

(21) Appl. No.: 13/539,035

(22) Filed: Jun. 29, 2012

(51) Int. Cl. H04N 7/01

(52) U.S. Cl. 348/448

(57) ABSTRACT

An image processing apparatus, system, and method to exclude a static region from a set of video frames, temporally interpolate the set of video frames having had the static region excluded therefrom to produce an interpolated video frame, and generate a video frame by combining the static region with the temporally interpolated video frame.

### BACKGROUND

Video systems have been developed, in part, to transmit video and multimedia data over networks and to display the video for viewing. In some instances, the video may be compressed, converted, and otherwise processed to facilitate transmission, reception, and displaying by various display devices. Important to a video viewing experience is the quality of video displayed for viewing by a user. In the event parts of the video processed for display include video artifacts and other visually perceptive irregularities, then the user's video viewing experience may be compromised.

A number of techniques have been proposed to compensate for motion in video processes by interpolating video frames. In many respects, some motion interpolation techniques have difficulty generating interpolated video frames that accurately represent both motion and static regions within the interpolated video frame. Improving the effectiveness and efficiency of video interpolation is therefore seen as important.

### BRIEF DESCRIPTION OF THE DRAWINGS

Aspects of the present disclosure herein are illustrated by way of example and not by way of limitation in the accompanying figures. For purposes related to simplicity and clarity of illustration rather than limitation, aspects illustrated in the figures are not necessarily drawn to scale. Further, where considered appropriate, reference labels have been repeated among the figures to indicate corresponding or analogous elements.

FIGS. 1A and 1B are illustrative depictions of corresponding video base frames, according to some embodiments herein.

FIGS. 1C, 1D, and 1E are illustrative depictions of the FIG. 1A video frame at various stages of processing.

FIGS. 1F, 1G, and 1H are illustrative depictions of the FIG. 1B video frame at various stages of processing, according to some embodiments herein.

FIG. 2 is a flow diagram of a process, in accordance with one embodiment.

FIG. 3 is an illustrative block diagram of a system including a process flow, in accordance with one embodiment.

FIGS. 4A-4H are illustrative depictions of corresponding video frames at various stages of processing, according to some embodiments herein.

FIG. 5 illustrates a system, in accordance with some embodiments herein.

FIG. 6 is an illustration of an embodiment of the system of FIG. 5, according to an embodiment herein.

### DETAILED DESCRIPTION

The following description describes an image processing method, device, or system that may support processes and operation to improve efficiency and accuracy of generating interpolated frames of video. The disclosure herein provides numerous specific details such regarding a system for implementing the processes and operations. However, it will be appreciated by one skilled in the art(s) related hereto that embodiments of the present disclosure may be practiced without such specific details. Thus, in some instances aspects such as control mechanisms and full software instruction sequences have not been shown in detail in order not to obscure other aspects of the present disclosure. Those of ordinary skill in the art will be able to implement appropriate functionality without undue experimentation given the included descriptions herein.

References in the specification to “one embodiment”, “some embodiments”, “an embodiment”, “an example embodiment”, “an instance”, “some instances” indicate that the embodiment described may include a particular feature, structure, or characteristic, but that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Some embodiments herein may be implemented in hardware, firmware, software, or any combinations thereof. Embodiments may also be implemented as executable instructions stored on a machine-readable medium that may be read and executed by one or more processors. A machine-readable storage medium may include any tangible non-transitory mechanism for storing information in a form readable by a machine (e.g., a computing device). In some aspects, a machine-readable storage medium may include read only memory (ROM); random access memory (RAM); magnetic disk storage media; optical storage media; flash memory devices; and electrical and optical forms of signals. While firmware, software, routines, and instructions may be described herein as performing certain actions, it should be appreciated that such descriptions are merely for convenience and that such actions are in fact result from computing devices, processors, controllers, and other devices executing the firmware, software, routines, and instructions.

Frame interpolation may be used in a number of different video processes including, for example, frame rate conversions, distributed video coding, and other processes. In general, a motion interpolation process involves identifying existing base or key frames and generating intermediate video frame(s) to insert between the base frames. In some aspects, playback of a video sequence including the base frames and the interpolated frames therebetween results in a smoother or more fluid animation of the motion in the video.

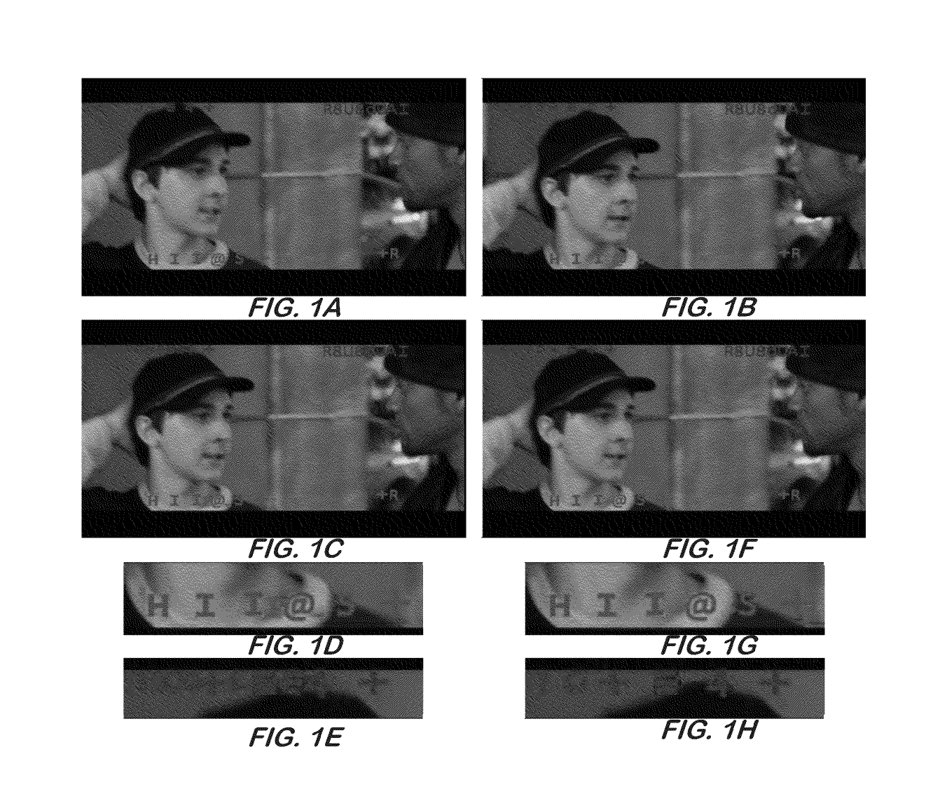

FIGS. 1A and 1B are illustrative depictions of a pair of base frames from a video sequence. As illustrated in these figures, each figure includes a static region of text at both an upper edge and a lower edge of the based frames. In the example of FIGS. 1A and 1B, the static regions comprise text that is in the same location (i.e., static) in both video frames of FIGS. 1A and 1B. In some instances, the static regions may include titles, logotypes, etc.

FIG. 1C is an illustrative depiction of a conventionally interpolated video frame generated based on the base frames of FIGS. 1A and 1B. As shown, the wording of the static text regions is not very clear. Instead, the static text of FIG. 1C includes video artifacts such as, for example, edge fuzziness, ghosting, etc. The video artifacts present in FIG. 1C may be the result of a motion interpolation process that attempts to interpolate video frames including static regions. FIGS. 1D and 1E both include a detailed view of some of the static text from FIG. 1C, including the video artifacts in the area or vicinity of the static region.

FIG. 1F is an illustrative depiction of an interpolated frame based on base frames 1A and 1B, generated according to an interpolation process that will be described in greater detail below. As shown in FIG. 1F, the static region text in the interpolated frame of 1D is clear, without the video artifacts shown in FIGS. 1C, 1D, and 1E. That is, the interpolated video frame of FIG. 1F is the result of a motion interpolation process that accurately renders static regions in video frames including static and non-static regions. FIGS. 1G and 1H both include a detailed view of some of the static text from FIG. 1F, illustrating the sharpness of the static text region in the interpolated video frame.

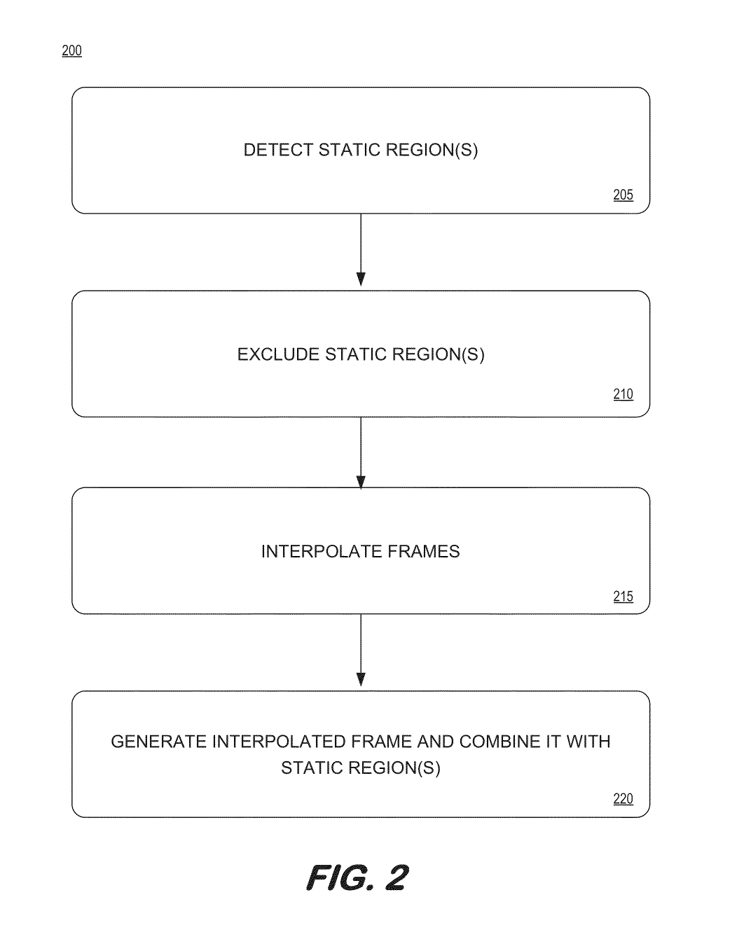

FIG. 2 is an illustrative depiction of a flow chart of an overview of an interpolation process, generally represented by the reference number 200. Process 200 may be used to interpolate video frames, in accordance with one embodiment herein. Process 200 may include an operation 205 to detect a static region in a set of base frames. The base frames may be selected from a video sequence comprising a plurality of video frames and the set of base frames may include at least two base frames. At operation 205, base frames identified for processing are analyzed to determine whether the base frames include any static regions.

In the instance it is determined at operation 205 that the base frames include static regions, the static regions are excluded from the base frames at operation 210. Having excluded the static regions from the base frames at operation 210, the base frames are temporally interpolated at operation 215 to generate interpolated frames(s) located, time-wise, between the base frames.

In some aspects, in the instance it is determined at operation 205 that the base frames do not include any detectable static region(s), an alternative motion interpolation process may be used to interpolate the base frames. In some aspects, process 200 may be modified to, for instance, bypass operations 210 and 220. In another embodiment, process 200 may continue as depicted in FIG. 2, wherein the detected and excluded static region(s) are logically “empty” or null.

At operation 220, the static regions previously excluded from the base frames are combined with the interpolated frame(s) of operation 215 to generate a combined video frame(s) including the interpolated frame(s) and the static regions. An output of operation 220 may be used in a frame conversion process or other video processes that may use or include a motion interpolation process.

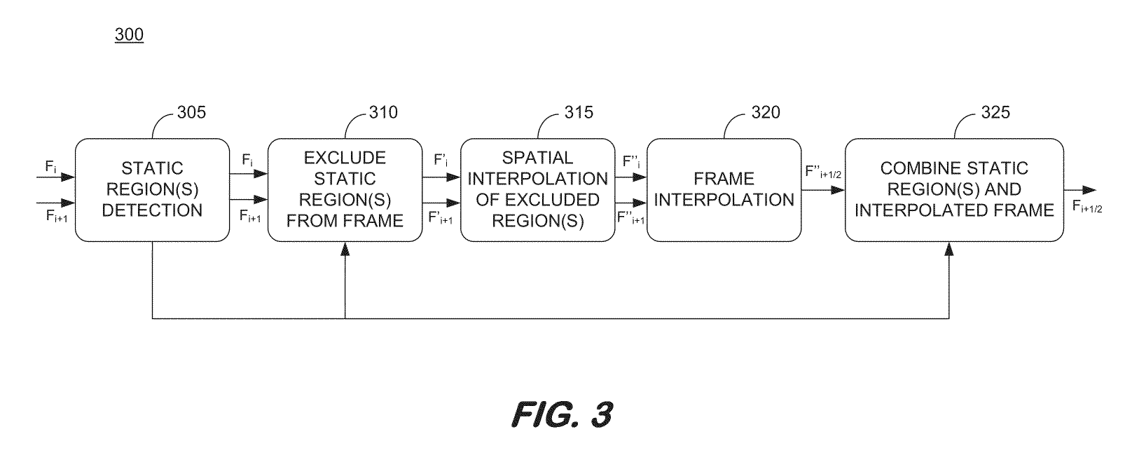

As stated above, process 200 is a flow diagram of an overview of an interpolation process, in accordance with an embodiment herein. FIG. 3 is an illustrative block diagram of a system including a flow through the functional blocks of the system. The functional blocks of FIG. 3 may be implemented in a variety of manners using hardware, firmware, software, and combinations thereof without limit, in accordance with embodiments herein.

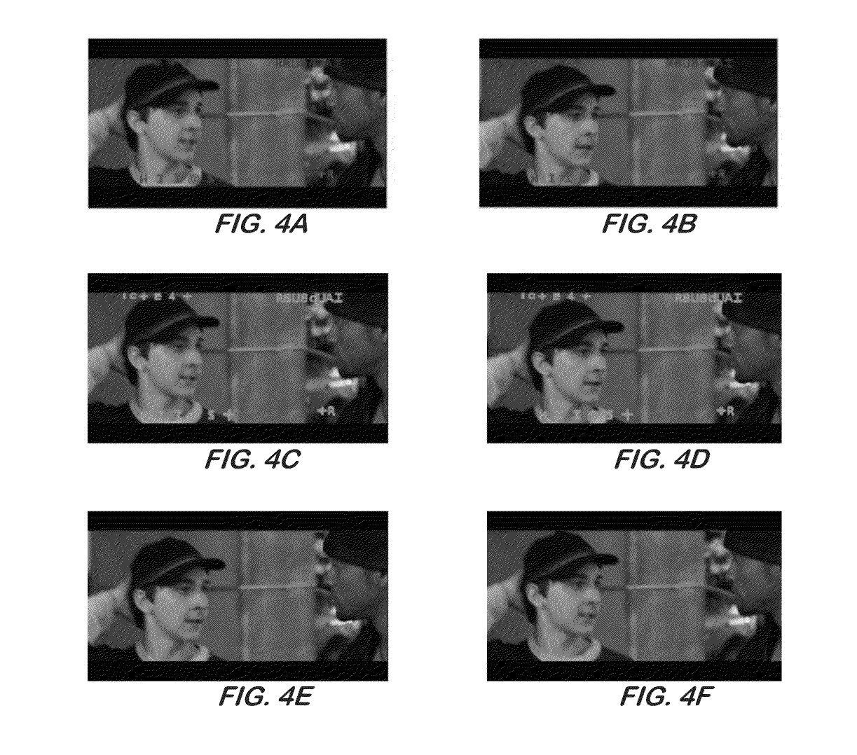

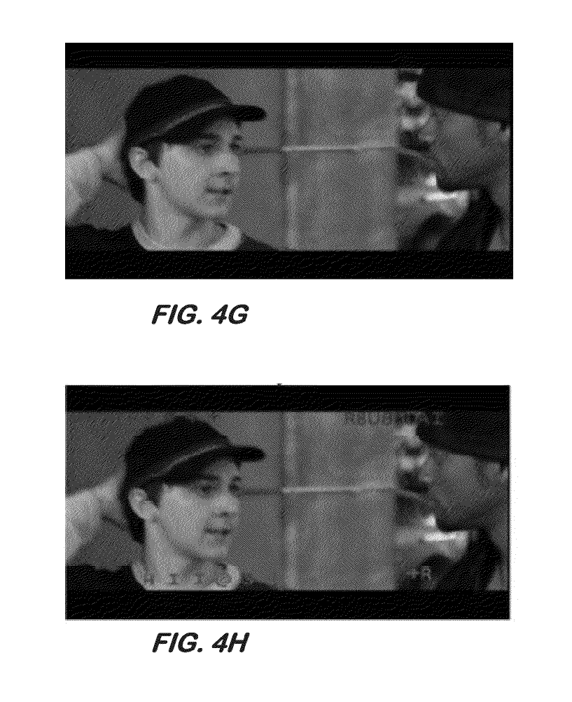

Inputs to system 300 include base frames, including video frame Fᵢ and Fᵢ₊₁, where i denotes a time. Accordingly, each base frame occurs at a different time in a video sequence. At block 305, the base frames are analyzed to detect the static regions in the frames, if any. In some aspects, the static region(s) detection module 305 may operate to calculate a binary map of the static elements in the base frames. The calculated binary map or other mechanism used to represent the detected static regions of the base frames may be stored or recorded in a memory. FIGS. 4A and 4B are illustrative examples of the base frames Fᵢ and Fᵢ₊₁, respectively.

System module or block 310 may exclude the static regions from the base frames (Fᵢ and Fᵢ₊₁), as detected by the static regions detection module 305. In some embodiments, module 310 may operate to mark or otherwise indicate the static elements comprising the detected static regions. The static elements marked by module 310 may correspond to the static elements associated with a binary map generated by module 305. In the present example, the static regions are marked by highlighting the detected static regions with a particular “highlight” color. Other mechanisms and techniques for marking the static regions for further processing may be used in some embodiments. FIGS. 4C and 4D are illustrative examples of an output of module 310 (e.g., F′ᵢ and F′ᵢ₊₁), wherein the base frames have the static regions therein marked or emphasized. The specific highlight color or other mechanisms used to mark or indicate the location and extent of the static regions by module 310 may be used by the spatial interpolation module 315 to recognize the static regions.

Spatial interpolation module 315 operates to “fill-in” the excluded regions. In some aspects, the “filling-in” of the excluded static regions replaces the elements in the static regions with elements and objects determined “likely” to be located under or behind the static regions. In some embodiments, one or more inpainting algorithms may be used for “filling-in” the area of the excluded static regions. The particular inpainting algorithms used in a particular use case may depend, in some aspects, on the content of the video frames (e.g., amount of motion, textures, colors, lighting, etc.). FIGS. 4E and 4F are illustrative examples of an output of module 315 (e.g., F″ᵢ and F″ᵢ₊₁), wherein the base frames have the static regions therein excluded and filled-in with the determined “likely” background colors and/or textures.

In some aspects, the functions of modules 310 and 315 may be accomplished by one module that performs both the static regions exclusion operation and the spatial interpolation operation. In some embodiments, shared resources may be used for the functions of modules 310 and 315 (as well as some other operations, though not specifically stated).

Module 320 may operate to temporally interpolate the video frames output by module 315 (i.e., video frames F″ᵢ and F″ᵢ₊₁). That is, module 320 interpolates the base frames having the excluded or removed and inpainted static regions. In this manner, module 320 may provide a time-wise interpolated video frame (i.e., video frame F″_{i+1/2}) that is temporally located between the base frames. FIG. 4G is an illustrative example of an output of module 320 (e.g., F″_{i+1/2}), wherein the generated temporally interpolated frame does not include the static regions and the area of the static regions is inpainted.

Module 325 operates to combine the interpolated video frame generated by module 320 (i.e., video frame F″_{i+1/2}) with the previously detected static regions detected by module 305. The input of module 325 includes the temporally interpolation generated frame F″_{i+1/2} and the static regions from static regions detection module 305. An example of the combined video frame output by module 325 is depicted in FIG. 4H, wherein the video frame includes the temporally interpolated frame and the static regions.

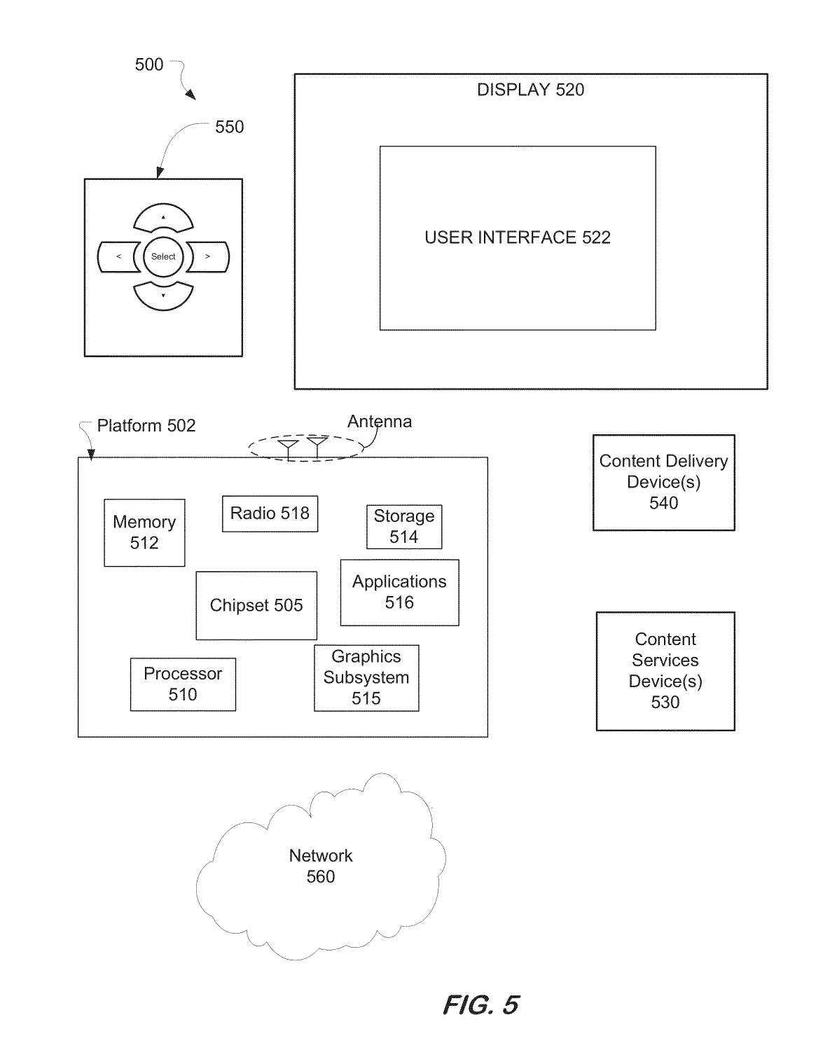

FIG. 5 illustrates an embodiment of a system 500. In embodiments, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 500 comprises a platform 502 coupled to a display 520. Platform 502 may receive content from a content device such as content services device(s) 530 or content delivery device(s) 540 or other similar content sources. A navigation controller 550 comprising one or more navigation features may be used to interact with, for example, platform 502 and/or display 520. Each of these components is described in more detail below.

In embodiments, platform 502 may comprise any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 510 may comprise dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 514 may comprise technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 could be integrated into processor 510 or chipset 505. Graphics subsystem 515 could be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 518 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In embodiments, display 520 may comprise any television type monitor or display. Display 520 may comprise, for example, a computer display screen, touch screen display, video monitor, television-like device, and/or a television. Display 520 may be digital and/or analog. In embodiments, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In embodiments, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In embodiments, content services device(s) 530 may comprise a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 receives content such as cable television programming including media information, digital information, and/or other content. Examples of content providers may include any cable or satellite television or radio or Internet content providers. The provided examples are not meant to limit embodiments of the invention.

In embodiments, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be echoed on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but integrated into platform 502 and/or display 520. Embodiments, however, are not limited to the elements or in the context shown or described herein.

In embodiments, drivers (not shown) may comprise technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 when the platform is turned “off.” In addition, chip set 505 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the invention.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

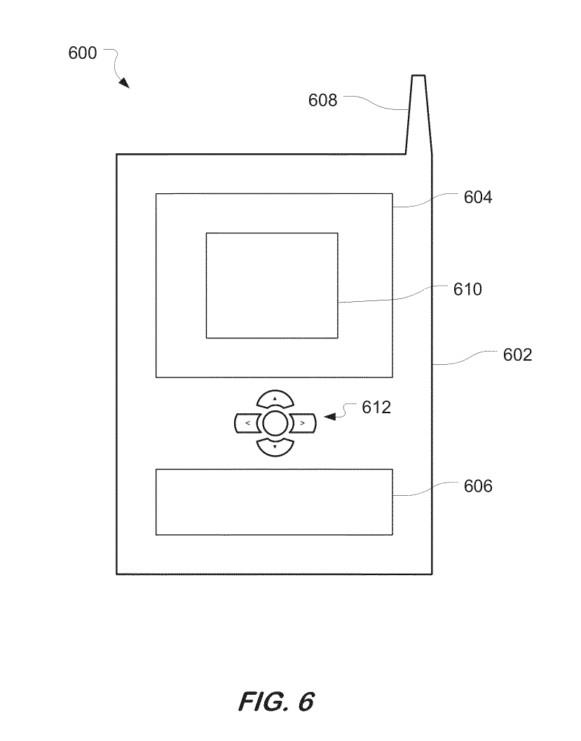

As described above, system 500 may be embodied in varying physical styles or form factors. FIG. 6 illustrates embodiments of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise navigation features 612. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

All systems and processes discussed herein may be embodied in program code stored on one or more computer-readable media. Such media may include, for example, a floppy disk, a CD-ROM, a DVD-ROM, one or more types of “discs”, magnetic tape, a memory card, a flash drive, a solid state drive, and solid state Random Access Memory (RAM) or Read Only Memory (ROM) storage units. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

1. A computer-implemented method, the method comprising:
excluding a static region from a set of video frames;
removing the static region from the set of video frames;
spatially interpolating the set of video frames to fill-in areas from which the static region is removed;
temporally interpolating the set of video frames having had the static region excluded therefrom to produce an interpolated video frame; and
generating a video frame by combining the static region with the temporally interpolated video frame.

2. The method of claim 1, wherein the static region comprises multiple regions in the set of video frames.

3. The method of claim 1, further comprising detecting the static region in the set of video frames.

4. The method of claim 3, further comprising:
generating a static map associated with an area of the set of video frames corresponding to the detected static region;
excluding the static region based on the static map; and
combining the static region with the interpolated video frame based on the static map.

5. (canceled)

6. The method of claim 1, wherein the set of video frames comprises a plurality of identified video key frames.

7. A system to generate interpolated video sequences, the system comprises:
a machine readable medium having processor executable instructions stored thereon; and
a processor to execute the instructions to:
exclude a static region from a set of video frames;
remove the static region from the set of video frames;
spatially interpolate the set of video frames to fill-in areas from which the static region is removed;
temporally interpolate the set of video frames having had the static region excluded therefrom to produce an interpolated video frame; and
generate a video frame by combining the static region with the temporally interpolated video frame.

8. The system of claim 7, wherein the static region comprises multiple regions in the set of video frames.

9. The system of claim 7, further comprising detecting the static region in the set of video frames.

10. The system of claim 9, wherein the processor is further instructed to:
generate a static map associated with an area of the set of video frames corresponding to the detected static region;
exclude the static region based on the static map; and
combine the static region with the interpolated video frame based on the static map.

11. (canceled)

12. The system of claim 7, wherein the set of video frames comprises a plurality of identified video key frames.

13. A non-transitory computer-readable medium storing processor-executable instructions thereon, the medium comprising:
instructions to exclude a static region from a set of video frames;
instructions to remove the static region from the set of video frames;
instructions to spatially interpolate the set of video frames to fill-in areas from which the static region is removed;
instructions to temporally interpolate the set of video frames having had the static region excluded therefrom to produce an interpolated video frame; and
instructions to generate a video frame by combining the static region with the temporally interpolated video frame.

14. The medium of claim 13, wherein the static region comprises multiple regions in the set of video frames.

15. The medium of claim 13, further comprising detecting the static region in the set of video frames.

16. The medium of claim 15, further comprising:
instructions to generate a static map associated with an area of the set of video frames corresponding to the detected static region;
instructions to exclude the static region based on the static map; and
instructions to combine the static region with the interpolated video frame based on the static map.

17. (canceled)

18. The medium of claim 13, wherein the set of video frames comprises a plurality of identified video key frames.
